(19) United States
(12) Patent Application Publication
(10) Pub. No.: US 2007/0049690 A1
(43) Pub. Date: Mar. 1, 2007

(54) Impact modified poly(arylene ether)/polyester blends and method

(76) Inventors: Pravin Borade, Nashik (IN); Manatesh Chakraborty, Mumbai (IN); Roshan Kumar Jha, Bangalore (IN); Nisha Preschilla, Bangalore (IN)

Correspondence Address: CANTOR COLBURN, LLP, 55 GRIFFIN ROAD SOUTH, BLOOMFIELD, CT, 06002, US

(21) Appl. No.: 11/214,105

(22) Filed: Aug. 29, 2005

(51) Int. Cl. C08L 53/00

(52) U.S. Cl. 525/92 D

(57) ABSTRACT

Disclosed herein is a polymer composition comprising: a poly(arylene ether) resin; a polyester resin; two impact modifiers; and a polymeric compatibilizer.

### BACKGROUND OF THE INVENTION

Disclosed herein is a blend of poly(arylene ether) resin and thermoplastic polyester resin that exhibits enhanced properties, such as improved ductility and heat resistance and low moisture absorption.

Poly(arylene ether) resins (referred to hereafter as “PAE”) are commercially attractive materials because of their unique combination of properties, including, for example, high temperature resistance, dimensional and hydrolytic stability and electrical properties. The combination of PAE with nylons into compatibilized PAE-nylon blends is well known in the industry and used in applications requiring improved ductility and solvent resistance. These blends have found particular use in automotive applications. Combinations of PAE with polyesters into compatibilized PAE-polyester blends are also known.

Compatibilized PAE-polyester blends seek to achieve a balance of properties needed for commercial applications, such as dimensional stability, heat resistance, and ductility. Unfortunately, known PAE-polyester blends do not provide a sufficient balance of properties to make them commercially attractive. It is therefore apparent that a need continues to exist for compatibilized PAE-polyester blends, which overcome the aforementioned difficulties.

### BRIEF DESCRIPTION OF THE INVENTION

The needs discussed above have been satisfied by resin composition comprising:
a poly(arylene ether) resin;
a polyester resin;
a first impact modifier;
a second impact modifier comprising less than or equal to 5.5 wt % structural units comprising a pendant epoxy group; and
a polymeric compatibilizer comprising greater than or equal to 6 wt % structural units comprising a pendant epoxy group wherein a portion of the poly(arylene ether) is functionalized poly(arylene ether).

A method for preparing the compositions is also provided.

### BRIEF DESCRIPTION OF THE DRAWINGS

FIG. 1 shows a TEM of a poly(arylene ether)-polyester blend taken from a molded test part.

FIG. 2 shows a TEM of a poly(arylene ether)-polyester blend taken from a molded test part and further comprising conductive carbon black.

### DETAILED DESCRIPTION OF THE INVENTION

The resin composition described above is a compatibilized PAE-polyester composition that has a stable phase morphology with the first impact modifier residing predominately within the PAE phase and the second impact modifier residing predominately within the polyester phase. The composition exhibits a unique combination of good heat resistance, dimensional stability and improved impact properties.

In the following specification and the claims that follow, reference will be made to a number of terms, which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

As used herein, a “poly(arylene ether)” comprises a plurality of structural units of the formula (I): 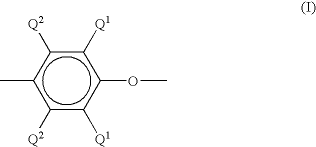
wherein for each structural unit, each Q¹ and Q² is independently hydrogen, halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) may be in the form of a homopolymer; a copolymer; a graft copolymer; an ionomer; or a block copolymer; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

At least a portion of the poly(arylene ether) is functionalized with a polyfunctional compound (functionalizing agent) such as a polycarboxylic acid or those compounds having in the molecule both (a) a carbon-carbon double bond or a carbon-carbon triple bond and b) at least one carboxylic acid, anhydride, amino, imide, hydroxy group or salts thereof. Examples of such polyfunctional compounds include maleic acid, maleic anhydride, fumaric acid, and citric acid.

In some embodiments the PAE can comprise 0.1 wt % to 3 wt % of structural units derived from a functionalizing agent. Within this range, the PAE can comprise less than or equal to 1 wt %, or, more specifically, less than or equal to 0.5 wt % of structural units derived from functionalizing agent.

The poly(arylene ether) can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s has an initial intrinsic viscosity of 0.1 to 0.60 deciliters per gram (dl/g), as measured in chloroform at 25° C. Initial intrinsic viscosity is defined as the intrinsic viscosity of the poly(arylene ether) prior to compounding with the other components of the composition. As understood by one of ordinary skill in the art the viscosity of the poly(arylene ether) may be up to 30% higher after compounding. The percentage of increase can be calculated by (final intrinsic viscosity—initial intrinsic viscosity)/initial intrinsic viscosity. Determining an exact ratio, when two initial intrinsic viscosities are used, will depend somewhat on the exact intrinsic viscosities of the poly(arylene ether) used and the ultimate physical properties that are desired.

The poly(arylene ether) is present in an amount of 18 to 65 weight percent based on the total weight of the entire composition. Within this range the poly(arylene ether) may be present in an amount greater than or equal to 20, or, more specifically, greater than or equal to 22 or, even more specifically, greater than or equal to 25 weight percent. Also within this range the poly(arylene ether) may be present in an amount less than or equal to 60, or, more specifically, less than or equal to 55 or, even more specifically, less than or equal to 50 weight percent.

Suitable polyesters include those comprising structural units of the formula (II): 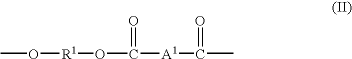
wherein each R¹ is independently a divalent aliphatic, alicyclic or aromatic hydrocarbon radical, or mixtures thereof and each A¹ is independently a divalent aliphatic, alicyclic or aromatic radical, or mixtures thereof. Examples of suitable polyesters comprising the structure of formula (II) are poly(alkylene dicarboxylate)s, liquid crystalline polyesters, polyarylates, and polyester copolymers such as copolyestercarbonates and polyesteramides. Also included are polyesters that have been treated with relatively low levels of diepoxy or multi-epoxy compounds. It is also possible to use branched polyesters in which a branching agent, for example, a glycol having three or more hydroxyl groups or a trifunctional or multifunctional carboxylic acid has been incorporated. Treatment of the polyester with a trifunctional or multifunctional epoxy compound, for example, triglycidyl isocyanurate can also be used to make branched polyester. Furthermore, it is sometimes desirable to have various concentrations of acid and hydroxyl endgroups on the polyester, depending on the ultimate end-use of the composition.

In one embodiment at least some of the polyester comprises nucleophilic groups such as, for example, carboxylic acid groups. In some instances, it is desirable to reduce the number of acid endgroups, typically to less than 30 micro equivalents per gram of polyester, with the use of acid reactive species. In other instances, it is desirable that the polyester has a relatively high carboxylic end group concentration, e.g., 5 to 250 micro equivalents per gram of polyester or, more specifically, 20 to 70 micro equivalents per gram of polyester.

In one embodiment, the R¹ radical in formula (II) is a C₂₋₁₀ alkylene radical, a C₆₋₁₀ alicyclic radical or a C₆₋₂₀ aromatic radical in which the alkylene groups contain 2-6 and most often 2 or 4 carbon atoms. The A¹ radical in formula (II) is most often p- or m-phenylene or a mixture thereof. This class of polyesters includes the poly(alkylene terephthalates), the poly(alkylene naphthalates) and the polyarylates. Exemplary poly(alkylene terephthalates), include, poly(ethylene terephthalate) (PET), poly(cyclohexanedimethanol terephthalate) (PCT), and poly(butylene terephthalate) (PBT). Exemplary poly(alkylene naphthalate)s include poly(butylene-2,6-naphthalate) (PBN) and poly(ethylene-2,6-naphthalate) (PEN). Other useful polyesters include poly(ethylene-co-cyclohexanedimethanol terephthalate) (PETG), polytrimethylene terephthalate (PTT), poly(dimethanol-1,4-cyclohexanedicarboxylate) (PCCD), and polyxylene terephthalate (PXT). Polyesters are known in the art as illustrated by the following U.S. Pat. Nos. 2,465,319, 2,720,502, 2,727,881, 2,822,348, 3,047,539, 3,671,487, 3,953,394, and 4,128,526.

Liquid crystalline polyesters having melting points less that 380° C. and comprising recurring units derived from aromatic diols, aliphatic or aromatic dicarboxylic acids, and aromatic hydroxy carboxylic acids are also useful. Examples of useful liquid crystalline polyesters include, but are not limited to, those described in U.S. Pat. Nos. 4,664,972 and 5,110,896. Mixtures of polyesters are also sometimes suitable.

The various polyesters can be distinguished by their corresponding glass transition temperatures (Tg) and melting points (Tm). The liquid crystalline polyesters generally have Tg's and Tm's that are higher than the naphthalate-type polyesters. The naphthalate-type polyesters generally have Tg's and Tm's that are higher than the terephthalate-type polyesters. Thus, the resultant PAE alloys with the liquid crystalline or naphthalate-type polyesters are typically better suited to applications requiring higher temperature resistance than are the terephthalate-type polyesters. The PAE alloys with terephthalate-type polyesters are generally easier to process due to the polyesters' lower Tg's and Tm's. Selection of the polyester or blend of polyesters utilized is therefore determined, in part, by the desired property profile required by the ultimate end-use application for the composition.

Because of the tendency of polyesters to undergo hydrolytic degradation at the high extrusion and molding temperatures in some embodiments the polyester is substantially free of water. The polyester may be predried before admixing with the other ingredients. Alternatively, the polyester can be used without predrying and the volatile materials can be removed through the use of vacuum venting the extruder. The polyesters generally have number average molecular weights in the range of 20,000-70,000, as determined by gel permeation chromatography (GPC) at 30° C. in a 60:40 by weight mixture of phenol and 1,1,2,2-tetrachloroethane.

The composition can comprise 35 to 70 weight percent of the polyester resin, based on the total weight of the composition. Within this range, the composition can comprise greater than or equal to 38 weight percent, or, more specifically, greater than or equal to 40 weight percent, or, even more specifically, greater than or equal to 45 weight percent polyester resin. Also, within this range the composition can comprise less than or equal to 67 weight percent, or, more specifically, less than or equal to 65 weight percent, or, even more specifically, less than or equal to 62 weight percent polyester resin.

The composition also comprises at least two impact modifiers, i.e., additives that improve the impact properties of the composition, for example notched Izod impact strength. In many embodiments the first impact modifier resides primarily in the poly(arylene ether) phase. Examples of suitable first impact modifiers include block copolymers; elastomers such as polybutadiene; random copolymers such as ethylene vinyl acetate (EVA); and combinations comprising at least one of the foregoing impact modifiers.

Particularly suitable first impact modifiers comprise block copolymers, for example, A-B diblock copolymers and A-B-A triblock copolymers having one or two blocks A, which comprise structural units derived from at least one alkenyl aromatic monomer, for example styrene; and a rubber block, B, which generally comprises structural units derived from a diene such as isoprene or butadiene. The diene block may be partially hydrogenated. Mixtures of these diblock and triblock copolymers are especially useful. In some embodiments the first impact modifier does not contain epoxy functionality.

Suitable A-B and A-B-A copolymers include, but are not limited to, polystyrene-polybutadiene; polystyrene-poly(ethylene-butylene); polystyrene-polyisoprene; polystyrene-poly(ethylene-propylene); poly(alpha-methylstyrene)-polybutadiene; poly(alpha-methylstyrene)-poly(ethylene-butylene); polystyrene-polybutadiene-polystyrene (SBS); polystyrene-poly(ethylene-butylene)-polystyrene (SEBS); polystyrene-polyisoprene-polystyrene; polystyrene-poly(ethylene-propylene)-polystyrene; poly(alpha-methylstyrene)-polybutadiene-poly(alpha-methylstyrene); as well as selectively hydrogenated versions thereof, and the like, as well as combinations comprising at least one of the foregoing impact modifiers. Such A-B and A-B-A block copolymers are available commercially from a number of sources, including Phillips Petroleum under the trademark SOLPRENE, Kraton Polymers, under the trademark KRATON, Dexco under the trademark VECTOR, and Kuraray under the trademark SEPTON.

In addition, the composition also comprises a second impact modifier. In many embodiments the second impact modifier resides predominately in the polyester phase. Suitable second impact modifiers comprise structural units comprising a pendant epoxy group. Structural units comprising a pendant epoxy group are derived from monomers comprising a pendant epoxy group. In some embodiments suitable second impact modifiers comprise structural units derived from at least one monomer comprising a pendant epoxy group and at least one olefinic monomer, wherein the content derived from the monomer comprising a pendant epoxy group is less than or equal to 5.5 weight percent (wt %) or, more specifically, less than or equal to 3 wt %. Without being limited by theory, it is believed that employing this level of structural units comprising a pendant epoxy group reduces the reactivity of the impact modifier with the polyester and reduces gelation in the polyester. Illustrative examples of suitable second impact modifiers include, but are not limited to, copolymers of glycidyl methacrylate (GMA) with alkenes, copolymers of GMA with alkenes and acrylic esters, and copolymers of GMA with alkenes and vinyl acetate. In some embodiments suitable alkenes comprise ethylene, propylene or a mixture comprising ethylene and propylene. In some embodiments acrylic esters comprise alkyl acrylate monomers, including, but not limited to, methyl acrylate, ethyl acrylate, propyl acrylate, butyl acrylate and mixtures of the foregoing alkyl acrylate monomers. When present, the acrylic ester may be used at a level of 15 wt % to 35 wt % based on the total amount of monomer used in the copolymer. When present, vinyl acetate may be used at a level of 4 wt % to 10 wt % based on the total amount of monomer used in the copolymer.

Suitable second impact modifiers include, but are not limited to, those available from commercial sources, including DuPont under the trademark ELVALOY PTW (which is a copolymer comprising structural units derived from ethylene, butyl acrylate, and glycidyl methacrylate), Sumitomo Chemical Co., Ltd. under the trademark IGETABOND 7L (which is a copolymer comprising structural units derived from 67 wt % ethylene, 30 wt % methyl acrylate, and 3 wt % glycidyl methacrylate); IGETABOND 2A and 7A (which are both copolymers comprising structural units derived from 89 wt % ethylene, 8 wt % vinyl acetate, and 3 wt % glycidyl methacrylate); and Atofina under the trademark LOTADER AX8930 (which is a copolymer comprising structural units derived from 63 wt % ethylene, 24 wt % methyl acrylate, and 3 wt % glycidyl methacrylate); LOTADER AX8860 (which is a copolymer comprising structural units derived from 67.5 wt % ethylene, 30 wt % methyl acrylate, and 2.5 wt % glycidyl methacrylate); and LOTADER AX8920 (which is a copolymer comprising structural units derived from 63 wt % ethylene, 26 wt % methyl acrylate, and 1 wt % glycidyl methacrylate). Mixtures of the aforementioned second impact modifiers may also be employed. In one embodiment the second impact modifier is substantially stable at the processing temperature of the final resinous composition.

The amount of the first impact modifier and the second impact modifier combined is 10 wt % to 22 wt %, based on the total weight of the composition. Within this range, the combined impact modifiers may be present in amount greater than or equal to 12 wt %, or, more specifically, greater than or equal to 14 wt %, or, even more specifically, greater than or equal to 15 wt %. Also within this range, the combined impact modifiers may be present in amount less than or equal to 20 wt %, or, more specifically, less than or equal to 19 wt %, or, even more specifically, less than or equal to 17 wt %. The exact amount and types or combinations of impact modifiers utilized will depend in part on the requirements needed in the final blend composition and may be determined by those skilled in the art.

In addition to the poly(arylene ether) resin, polyester resin, and impact modifiers, the composition also comprises a polymeric compatibilizer. As used herein and throughout, a polymeric compatibilizer is a polymeric polyfunctional compound that interacts with the poly(arylene ether) resin, the polyester resin, or both. This interaction may be chemical (e.g. grafting) and/or physical (e.g. affecting the surface characteristics of the dispersed phases). When the interaction is chemical, the compatibilizer may be partially or completely reacted with the poly(arylene ether) resin, polyester resin or both such that the composition comprises a reaction product. Use of the polymeric compatibilizer can improve the compatibility between the poly(arylene ether) and the polyester, as may be evidenced by enhanced impact strength, mold knit line strength, elongation and/or the formation of a distinctive two phase morphology. Such a morphology is evidenced by the occurrence of two distinct phases within a molded part; a continuous polyester phase and a second well dispersed poly(arylene ether) resin phase. The poly(arylene ether) resin phase can have an average particle diameter of 0.2 to 5 micrometers, or, more specifically, 0.5 to 4 micometers, or, even more specifically 0.5 to 3 micrometers.

Suitable polymeric compatibilizers comprise epoxy compounds, and include, but are not limited to, copolymers comprising structural units having pendant epoxy groups. In some embodiments suitable polymeric compatibilizers comprise copolymers comprising structural units derived from at least one monomer comprising a pendant epoxy group and at least one olefinic monomer, wherein the content derived from monomer comprising a pendant epoxy group is greater than or equal to 6 wt %, or, more specifically, greater than or equal to 8 wt %, or, even more specifically greater than or equal to 10 wt %. Illustrative examples of suitable compatibilizers include, but are not limited to, copolymers of glycidyl methacrylate (GMA) with alkenes, copolymers of GMA with alkenes and acrylic esters, copolymers of GMA with alkenes and vinyl acetate. Suitable alkenes comprise ethylene, propylene, and mixtures comprising ethylene and propylene. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, said acrylic ester may be used in an amount of 15 wt % to 35 wt % based on the total amount of monomer used in the copolymer. When present, vinyl acetate may be used in an amount of 4 wt % to 10 wt % based on the total amount of monomer used in the copolymer. Illustrative examples of suitable compatibilizers comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

Suitable impact modifiers are available from commercial sources, including Sumitomo Chemical Co., Ltd. under the trademarks BONDFAST 2C (also known as IGETABOND 2C; which is a copolymer comprising structural units derived from 94 wt % ethylene, and 6 wt % glycidyl methacrylate); BONDFAST E (also known as IGETABOND E; which is a copolymer comprising structural units derived from 88 wt % ethylene, and 12 wt % glycidyl methacrylate); IGETABOND 2B, 7B, and 20B (which are copolymers comprising structural units derived from 83 wt % ethylene, 5 wt % vinyl acetate, and 12 wt % glycidyl methacrylate); IGETABOND 7M and 20M (which are copolymers comprising structural units derived from 64 wt % ethylene, 30 wt % methyl acrylate, and 6 wt % glycidyl methacrylate); and from Atofina under the trademark LOTADER 8840 (which is a copolymer comprising structural units derived from 92 wt % ethylene, and 8 wt % glycidyl methacrylate); and LOTADER 8900 (which is a copolymer comprising structural units derived from 67 wt % ethylene, 25 wt % methyl acrylate, and 8 wt % glycidyl methacrylate). Mixtures of the aforementioned compatibilizers may also be employed. In one embodiment the compatibilizer is substantially stable at the processing temperature of the final resinous composition.

The composition comprises 0.1 wt % to 20 wt % of compatibilizer, based on the total weight of the composition. Within this range, the composition can comprise less than or equal to 15 wt %, or, more specifically less than or equal to 10 wt %, or, even more specifically, less than or equal to 8 wt % compatibilizer. Also within this range, the composition may comprise greater than or equal to 0.5 wt %, or, more specifically, greater than or equal to 1 wt %, or, even more specifically, greater than or equal to 4 wt % compatibilizer.

The foregoing compatibilizer may be added directly to the composition or pre-reacted with either or both of the poly(arylene ether) resin and polyester resin, as well as with other materials employed in the preparation of the composition. The initial amount of the compatibilizer used and order of addition will depend upon the specific compatibilizer chosen and the specific amounts of poly(arylene ether) resin and polyester resin employed, and may be readily determined by those skilled in the art.

The composition may optionally also comprise at least one conductive filler. The conductive filler may be any filler that increases the conductivity of the molded composition. Suitable conductive fillers may be fibrous, disc-shaped, spherical or amorphous and include, for example, conductive carbon black; conductive carbon fibers, including milled fibers; conductive vapor-grown carbon fibers, and various mixtures thereof. Other conductive fillers which can be used are metal-coated carbon fibers; metal fibers; metal disks; metal particles; metal-coated disc-shaped fillers such as metal-coated talcs, micas and kaolins; and the like. Preferred conductive fillers include carbon black, carbon fibers, and mixtures thereof, an illustrative example of which includes material available commercially from Akzo Chemical under the trademark Ketjen black EC600JD. In one embodiment, the carbon blacks include the conductive carbon blacks having average particle sizes of less than 200 nanometers, or, more specifically, less than 100 nanometers, or, even more specifically, less than 50 nanometers. Conductive carbon blacks may also have surface areas greater than 200 m²/g, or, more specifically, greater than 400 m²/g, or, even more specifically greater than 1000 m²/g. Conductive carbon blacks may also have a pore volume (as measured by dibutyl phthalate absorption) of greater than 40 cm³/100 g, or, more specifically, greater than 100 cm³/100 g, or, even more specifically, greater than 150 cm³/100 g. Conductive carbon blacks may also have a volatiles content less than 2 weight percent. Useful carbon fibers include the graphitic or partially graphitic vapor-grown carbon fibers having diameters of 3.5 to 500 nanometers, or, more specifically, diameters of 3.5 to 70 nanometers, or, even more specifically, diameters of 3.5 to 50 nanometers. Representative carbon fibers are the vapor-grown carbon fibers, such as those available from Hyperion and single wall nanotubes such as those available from Carbon Nanotechnologies Incorporated (CNI). Conductive fillers of this type are described in, for example, U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and U.S. Pat. No. 5,591,382 to Nahass et al.

Generally, the conductive filler will be present in an amount of 0.2 weight percent to 20 weight percent based on the total weight of the composition. The amount will depend on the nature of the conductive filler. For example, when the conductive filler is carbon black, the amount will generally be 1 to 10 wt %, or, more specifically, 1 to 8 wt %, or, even more specifically, 1.4 to 7 wt %. When the conductive filler is a vapor-grown carbon fiber, the amount will generally be 0.2 to 6 wt %, or, more specifically, 0.5 to 4 wt % based on the total weight of the composition. Conductive filler amounts less than the above lower limits often fail to provide adequate conductivity, while amounts greater than the above upper limits may tend to make the final blend brittle.

The composition may also comprise additives known in the art. Possible additives include anti-oxidants, dyes, pigments, colorants, stabilizers, small particle minerals (e.g., clay, mica, talc, and the like), flame retardants, drip retardants, crystallization nucleators, metal salts, antistatic agents, plasticizers, lubricants, and combinations comprising at least one of the foregoing additives. These additives are known in the art, as are their effective levels and methods of incorporation. Effective amounts of the additives vary widely, but they are usually present in an amount of less than or equal to 50 wt %, based on the total weight of the composition. Higher levels, in the range of 5 wt % to 50 wt % are levels that are typically employed when the additives comprise mineral type fillers. Amounts of these additives, without the use of mineral fillers, are generally 0.25 wt % to 2 wt %, based upon the total weight of the composition. The effective amount can be determined by those skilled in the art without undue experimentation.

The composition can be prepared using various techniques, including batch or continuous techniques that employ kneaders, extruders, mixers, and the like. For example, the composition can be formed as a melt blend employing a twin-screw extruder. In the extruder, the components, i.e., the poly(arylene ether) resin, polyester resin, impact modifiers, functionalizing agent, polymeric compatibilizer, and optional additives may all be added to the extruder at the feed throat or may be added sequentially (e.g., where some of the components are added downstream of the feed throat).

In one embodiment at least some of the components are added sequentially. For example, the poly(arylene ether) resin, the first impact modifier, and functionalizing agent may be added to the extruder at the feed throat or in feeding sections adjacent to the feed throat, while the polyester, polymeric compatibilizer, and second impact modifier may be added to the extruder in the subsequent feeding section downstream. A vacuum system may be applied to the extruder, prior to the second sequential addition, to generate a sufficient vacuum to lower the residual levels of non-reacted functionalizing agent and any other volatile materials. In an alternative embodiment, the sequential addition of the components may be accomplished through multiple extrusions. A composition may be made by preextrusion of selected components, such as the poly(arylene ether) resin, the first impact modifier and the functionalizing agent to produce a pelletized mixture. A second extrusion may then be employed to combine the preextruded components with the remaining components.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Compositions described herein were typically extruded on a WP 25 millimeter (mm) co-rotating intermeshing twin-screw extruder. The components of the compositions and their source are listed in Table 1. The poly(arylene ether), antioxidants, functionalizing agents and first impact modifier were added at the feed throat of the extruder and the polyester, second impact modifier and epoxy were added downstream. The extruder was set with barrel temperatures between 260° C. and 300° C. The material was run at 20 kilograms per hour (kg/hr) with the screw rotating at 400 rotations per minute (rpm) with a vacuum of 100 millibar (mbar)-800 mbar applied to the melt during compounding.

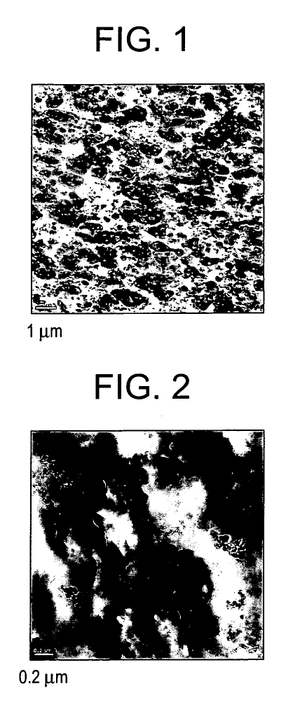

All samples were molded via injection molding with the molding machine set at 300° C. and mold set at 80° C., and tested for notched Izod impact strength (in units of kilojoules per square meter) according to ISO 180/1A. The tensile modulus (in units of gigapascals; Gpa) and % nominal strain at break were tested according to ISO 527. Multi-axial impact energy (in units of joules) was tested according to ISO 6603-2. Heat resistance (Vicat B) was measured according to ISO 306. Coefficient of thermal expansion (CTE) in the range of 30-60° C. was measured according to ISO 11359-2 and is presented in units of 10⁻⁵ m/m/° C. Specific volume resistivity (SVR) was determined as follows. A tensile bar was molded according to ISO 3167. A sharp, shallow cut was made near each end of the narrow central portion of the bar. The bar was fractured in a brittle fashion at each cut to separate the narrow central portion, now having fractured ends with dimensions of 10 ×4 millimeters. If necessary to obtain fracturing in a brittle fashion, the tensile bar was first cooled, for example, in dry ice or liquid nitrogen in a minus 40° C. freezer. The length of the bar between the fractured ends was measured. The fractured ends of the sample were painted with conductive silver paint, and the paint was allowed to dry. Using a multi-meter in resistance mode, electrodes were attached to each of the painted surfaces, and the resistance was measured at an applied voltage of 500-1000 millivolts. Values of the specific volume resistivity were obtained by multiplying the measured resistance by the fracture area of one side of the bar and dividing by the length according to the equation ρ=RxA/L where ρ is the specific volume resistivity in ohm-cm, R is the measured resistance in Ohms, A is the fractured area in cm², and L is the sample length in cm. The specific volume resistivity values thus have units of Ohm-cm and are presented as kilo Ohm-cm. Domain particle size was analyzed by transmission electron microscopy (TEM) with a Philips CM12 TEM, operated at 120 kV. Micrographs of typical microstructures were taken at appropriate magnifications (4400X and 8800X). 100 nm sections required for TEM studies were prepared by ultramicrotomy at room temperature. These sections were collected on a standard 3 mm, 400 mesh Cu TEM grid. TEM sections used to study poly(arylene ether) dispersion were vapor stained with freshly prepared RuO₄ solution for 30 seconds. A representative micrograph is presented as FIG. 1 and shows two distinct phases. The scale bar shown in this micrograph is 1 micron. The continuous light gray phase corresponds to polyester matrix and the dispersed dark gray phase corresponds to poly(arylene ether) phase, which has domain size diameter ranging from 0.3 to 3 microns. Conductive carbon black dispersion was studied using an unstained section, and carbon black was primarily seen in the polyester matrix phase or at the interface of poly(arylene ether) and polyester, as shown in FIG. 2. The scale bar in this micrograph is 0.2 microns.

The component amounts of each of the compositions are shown in Table 2, along with physical properties of molded test parts. The amount of each component is expressed in weight percent based on the total weight of the composition.

TABLE 1

| Component | Trade name/Supplier |
|---|---|
| Poly(arylene ether) | a poly(2,6-dimethyl-1,4-phenylene ether) |
| | having intrinsic viscosity of 0.38 dl/g/GE |
| | Plastics |
| Polyester | PCT 13787/Eastman |
| First Impact Modifier | SEBS KRATON 1651/Shell Chemical |
| | Co |
| Second Impact Modifier | Epoxidized Polyolefin ELVALOY PTW/ |
| | Dupont |
| Compatibilizer (BF E) | BONDFAST E/Sumitomo chemicals |
| Conductive carbon black | Ketjen black EC 600JD/Akzo Nobel |
| (CCB) | |
| Functionalizing agent | Citric acid/SD Fine Chemicals Ltd |
| Stabilizer | IRGANOX 1010 & IRGAFOS 168/Ciba |
| | Specialty Chemicals |

TABLE 2

| | | | Comp. | Comp. | Comp. | Comp. | Comp. | Comp. | Comp Ex. |
|---|---|---|---|---|---|---|---|---|---|
| | Ex. 1 | Ex. 2 | Ex. 1 | Ex. 2 | Ex. 3 | Ex. 4 | Ex. 5 | Ex. 6* | 7** |
| PAE | 24.8 | 24.8 | 25.5 | 24.8 | 24.8 | 24.8 | 24.8 | 24.8 | 24.8 |
| PCT | 54.4 | 56 | 54.4 | 54.4 | 54.4 | 54.4 | 54.4 | 54.4 | 54.4 |
| SEBS | 7 | 7 | 7 | 12 | — | 7 | 7 | 7 | 7 |
| Elvaloy PTW | 5 | 5 | 5 | — | 12 | 11 | — | 5 | 5 |
| BF E | 6 | 6 | 6 | 6 | 6 | — | 11 | 6 | 6 |
| CCB | 1.6 | — | 1.6 | 1.6 | 1.6 | 1.6 | 1.6 | 1.6 | 1.6 |
| Functionalizing | 0.7 | 0.7 | — | 0.7 | 0.7 | 0.7 | 0.7 | 0.7 | 0.7 |
| agent | | | | | | | | | |
| Stabilizer | 0.45 | 0.45 | 0.45 | 0.45 | 0.45 | 0.45 | 0.45 | 0.45 | 0.45 |
| Tensile Modulus | 1.59 | 1.21 | 1.54 | 1.84 | 1.39 | 1.42 | 1.76 | 1.55 | 1.77 |
| (Gpa) | | | | | | | | | |
| Break strain (%) | 26.3 | 45 | 4.51 | 12.5 | 10.5 | 15.6 | 22.7 | 6.0 | 25.7 |
| Notched Impact | 15.3 | 35.9 | 3.9 | 9.1 | 5.2 | 8.4 | 10.4 | 2.9 | 9.3 |
| (KJ/m²) | | | | | | | | | |
| Vicat B (° C.) | 167 | 135 | 148 | 168 | 121 | 140 | 169.5 | 165 | 170 |
| SVR (K ohm- | 100 | N/C | 716 | 7.8 | UL | 13.5 | UL | 1.9 | 59.1 |
| cm) | | | | | | | | | |
| Multi-axial | 54.8 | — | — | 6.75 | 12.5 | 16.1 | 40.8 | 3.0 | 43.8 |
| Impact (J) | | | | | | | | | |
| CTE @ 30-60° C. | 11.26 | — | — | — | — | — | — | — | — |
| (10⁻⁵ m/m/° C. | | | | | | | | | |

UL—Upper limit >10⁶ K ohm-cm
N/C—Non conductive
*BF E added upstream in the feed throat
**Vacuum not applied

Example 1 and Example 2 show good ductility as measured by notched Izod impact value, multi-axial impact, and % nominal break strain. Example 2 has a composition comparable to Example 1 without the addition of conductive filler, rendering the material non-conductive. Comparative Examples 1 through 5 have compositions comparable to Example 1 but lack certain components resulting in lower ductility in each instance. Comparative Example 1 lacks the functionalizing agent. Comparative Examples 2, 3 and 5 lack one of the aforementioned impact modifiers, even though the relative overall weight percent of impact modification is comparable to Example 1. Comparative Example 4 lacks the compatibilizer.

Comparative Example 6 employs the same components as Example 1, differing in the order of addition of the compatibilizer. In Comparative Example 6, the compatibilizer was added to the feed throat compared to Example 1 whereby it was added downstream. Surprisingly, Example 1 shows significantly higher ductility compared to Comparative Example 6.

Comparative Example 7 has a similar composition to Example 1. It differs in that a downstream vacuum was not applied during the compounding process. This resulted in a reduction in impact performance, as shown by reduction in notched Izod impact strength and multi axial impact energy compared to Example 1.

As can be seen from the foregoing examples, heat resistance also varied. Given the comparison between Example 1 and Comparative Example 1 one would expect similar heat performance due to the similarity in the composition, Example 1 differing only in the addition of 0.7 wt % citric acid. Surprisingly, Example 1 exhibits significantly improved heat resistance compared to Comparative Example 1. Similarly, Example 1 exhibits improved heat resistance compared to Comparative Example 4. One would expect Comparative Example 4, lacking the compatibilizer, would exhibit higher heat performance; surprisingly Example 1 has better heat performance.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A resin composition comprising:
a poly(arylene ether) resin;
a polyester resin;
a first impact modifier;
a second impact modifier comprising less than or equal to 5.5 wt % structural units comprising a pendant epoxy group; and
a polymeric compatibilizer comprising greater than or equal to 6.0 wt % structural units comprising a pendant epoxy group wherein a portion of the poly(arylene ether) is functionalized poly(arylene ether).

2. The composition of claim 1, wherein the functionalized poly(arylene ether) is the reaction product of poly(arylene ether) and a functionalizing agent selected from the group consisting of carboxylic acids, anhydrides, imides, amines, hydroxyls, and salts thereof.

3. The composition of claim 2 wherein the functionalizing agent is selected from the group consisting of maleic anhydride, citric acid, malic acid, and fumaric acid.

4. The composition of claim 1 wherein the polyester resin is a poly(alkylene dicarboxylate).

5. The composition of claim 4, wherein the poly(alkylene dicarboxylate) comprises at least one member selected from the group consisting of poly(ethylene terephthalate), poly(butylene terephthalate), poly(butylene-2,6-naphthalate), poly(ethylene-2,6-naphthalate), poly(cyclohexanedimethanol terephthalate), poly(ethylene-co-cyclohexanedimethanol terephthalate), polytrimethylene terephthalate, poly(dimethanol-1,4-cyclohexanedicarboxylate), and polyxylene terephthalate.

6. The composition of claim 1, wherein the first impact modifier is a block copolymer.

7. The composition of claim 6, wherein the copolymer is at least one member selected from the group consisting of polystyrene-polybutadiene; polystyrene-poly(ethylene-butylene); polystyrene-polyisoprene; polystyrene-poly(ethylene-propylene); poly(alpha-methylstyrene)-polybutadiene; poly(alpha-methylstyrene)-poly(ethylene-butylene); polystyrene-polybutadiene-polystyrene; polystyrene-poly(ethylene-butylene)-polystyrene; polystyrene-polyisoprene-polystyrene; polystyrene-poly(ethylene-propylene)-polystyrene; poly(alpha-methylstyrene)-polybutadiene-poly(alpha-methylstyrene); and combinations comprising at least one of the foregoing impact modifiers.

8. The composition of claim 1, wherein the second impact modifier comprising less than or equal to 3 wt % structural units comprising a pendant epoxy group.

9. The composition of claim 1, wherein the second impact modifier further comprises structural units derived from at least one olefinic monomer.

10. The composition of claim 9, wherein the second impact modifier comprises a copolymer comprising structural units derived from ethylene and glycidyl methacrylate; ethylene, alkyl acrylate, and glycidyl acrylate; ethylene, methyl acrylate, and glycidyl acrylate; ethylene, butyl acrylate, and glycidyl acrylate; or ethylene, vinyl acetate, and glycidyl acrylate.

11. The composition of claim 1, wherein the compatibilizer comprises greater than or equal to 8 wt % structural units comprising a pendant epoxy group.

12. The composition of claim 1, wherein the compatibilizer comprises greater than or equal to 10 wt % structural units comprising a pendant epoxy group.

13. The composition of claim 1, wherein the compatibilizer further comprises structural units derived from at least one olefinic monomer.

14. The composition of claim 1, wherein the compatibilizer comprises a copolymer comprising structural units derived from ethylene and glycidyl methacrylate; ethylene, alkyl acrylate, and glycidyl acrylate; ethylene, methyl acrylate, and glycidyl acrylate; ethylene, butyl acrylate, and glycidyl acrylate; or ethylene, vinyl acetate, and glycidyl acrylate.

15. The composition of claim 1, further comprising at least one additive selected from the group consisting of reinforcing fillers, metal salts, flow promoters, flame retardants, drip retardants, colorants, dyes, pigments, stabilizers, crystallization nucleators, plasticizers, non-reinforcing fillers and lubricants.

16. The composition of claim 1, further comprising a conductive filler.

17. The composition of claim 16, having a specific volume resistivity value of less than 100 kilo ohm-cm.

18. A resin composition comprising:
a poly(2,6-dimethyl-1,4-phenylene ether) resin;
a poly(cyclohexanedimethanol terephthalate) resin;
a first impact modifier selected from the group consisting of polystyrene-polybutadiene; polystyrene-poly(ethylene-butylene); polystyrene-polyisoprene; polystyrene-poly(ethylene-propylene); poly(alpha-methylstyrene)-polybutadiene; poly(alpha-methylstyrene)-poly(ethylene-butylene); polystyrene-polybutadiene-polystyrene; polystyrene-poly(ethylene-butylene)-polystyrene; polystyrene-polyisoprene-polystyrene; polystyrene-poly(ethylene-propylene)-polystyrene; poly(alpha-methylstyrene)-polybutadiene-poly(alpha-methylstyrene); and combinations comprising at least one of the foregoing impact modifiers;
a second impact modifier derived from ethylene and less than or equal to 5.5 wt % glycidyl methacrylate; and
a polymeric compatibilizer comprising derived from ethylene and greater than or equal to 6 wt % glycidyl methacrylate wherein a portion of the poly(2,6-dimethyl-1,4-phenylene ether) resin is functionalized poly(2,6-dimethyl-1,4-phenylene ether) resin.

19. The composition of claim 18, further comprising a conductive filler.

20. An article made from the composition of claim 1.

21. An article made from the composition of claim 16.

22. A method to prepare the composition of claim I comprising the steps of
a) melt mixing a composition comprising a poly(arylene ether), a first impact modifier and a functionalizing agent to form a first blend; and
b) melt mixing the said first blend with a mixture comprising a polyester, second impact modifier, compatibilizer, and optionally a conductive filler to form a final blend.

23. The method according to claim 22 wherein the melt mixing is performed in an extruder and said first blend is produced by upstream addition and the remaining components are added at a downstream feeding section.

24. The method according to claim 23 wherein a vacuum is applied to the extruder at a location after the upstream addition of said first blend and prior to the addition of remaining components to form said final blend.
